(19) United States
(12) Patent Application Publication
(10) Pub. No.: US 2020/0238752 A1
(43) Pub. Date: Jul. 30, 2020

(54) Uroll Paint Dispenser

(71) Applicant: Michael Rosenberg, Brooklyn, NY (US)

(72) Inventor: Michael Rosenberg, Brooklyn, NY (US)

(21) Appl. No.: 16/257,637

(22) Filed: Jan. 25, 2019

(51) Int. Cl. B44D 3/12; B05C 17/02

(52) U.S. Cl. CPC B44D 3/12; B05C 17/0245

(57) ABSTRACT

Disclosed are several variations of a device that is capable of dispensing small amounts of paint. The disclosed device may be used as a paint tester and a tool to perform small touch up and repair jobs on painted surfaces. The device will come preloaded with a small amount of paint and an applicator. The packaging is designed to promote mixture of the colorant and application of such colorant to the applicator. The adherence of colorant to the applicator is designed to occur as a one step process, as a user is removing an applicator from its packaging so as to apply a small measure of colorant to a surface. The packaging is also designed to maximize convenience by providing for a clean and drip resistant deployment of paint and virtually eliminating cleanup.

### FIELD OF THE INVENTION

The present invention relates to personal and mini paint dispensers that are high on convenience and low on cleanup.

### BACKGROUND OF THE INVENTION

Choosing the right paint color is usually the main deciding factor for interior and exterior decoration of structures. Color selection of Color selection is usually a lengthy process, involving much planning, forecasting, predicting and generally fussing about matchups, coordination, mood, lighting, etc. Typically, parties will spend many hours involving many trips to the hardware store for tester sets until a selection is finalized.

The current process of identifying the right color and combination is actually quite difficult, messy and wasteful. The smallest available tester jar of paint is about eight ounces, which should cover about sixteen square feet. This is obviously an overkill. It is well known that when testing paint, one only needs about two square feet. But a smaller tester jar is not available, in part because the quality of paint will suffer, and it is economically impractical. A further reason is that a tester jar is generally designed accommodate a conventional paint brush. This shortcoming in the prior art leads to the majority of paint being purchased for testing purposes being discarded and wasted, thus hurting the environment, and contributing to the costs of remodeling in a significant way.

Besides the conventionally available testing jar, one will also need to acquire a mixing tray, a small roller or a paint brush. There are at least three preliminary steps that are required before a speck of paint hits any surface. First, one must vigorously shake the jar or use a stirrer to mix the paint upon opening. The jar of paint is then emptied into a paint tray. A brush or roller is then saturated with paint from the paint tray and only then rolled onto the surface. As a prerequisite, it is generally recommended to rinse a never before used roller or brush before prior to its first use. Once a test is completed, one would still need to thoroughly wash the roller or the brush and the tray, or risk needing to purchase new samples of these items for further testing.

While some attempts have been made to improve the present state of the art, none of the testers are truly single use disposable jars, and do not merge applicator with paint in the same effective manner as when using the disclosed device.

### SUMMARY OF THE INVENTION

The present invention comprises a disposable cartridge that stores paint and paint applicator together or in close proximity with each other. Several embodiments of the novel device are shown. In some embodiments the application roller has been saturated with a paint solution but is kept in a vacuum pack to prevent drying and hardening of paint. In other embodiments, the applicator roller is separate from the paint, but is saturated with paint as soon as the test cartridge is opened or otherwise activated prior to applying a layer of paint on a designated surface.

The basic elements of the device disclosed with this application is a container or sleeve holding a paint roller and an amount of paint required to saturate the roller but not enough to produce undesirable runs and drips when a roller is removed from the sleeve. The paint may be kept in a separate chamber from the roller. The partition between the applicator chamber and the paint chamber is then removed in the process of opening and activating the disclosed device, such that upon removal, the applicator is ready to use while the sleeve may be immediately discarded or recycled.

A roller is the preferred applicator for the purpose of the present invention, since the roller is the most efficient applicator, producing an even stroke even when used by a novice. However, a brush may be utilized as the applicator using the same sleeve and paint saturation techniques described for a roller.

The disclosed device has many useful purposes. One such purpose as a testing device capable of dispensing small amounts of colorant on surfaces using a roller or brush. The dispensing process is highly controlled, precisely calibrated to avoid overfilling the paint applicator to a point were undesirable spills and paint runs are generated. The disclosed device is preferably prefilled with a quantity of colorant that may be stored for extended periods of time without drying or undermining the quality of the enclosed applicator.

There are many variations of a device which enables concepts disclosed herein. In some cases the applicator is kept separate from a quantity of colorant. The colorant is then not introduced until a user is ready to deploy the device from within a protective sleeve that surrounds the applicator and the chamber with paint. In other cases, the applicator may be pre-loaded with a quantity of colorant and stored in a saturated state inside the sleeve ready for deployment.

The color of the colorant may be set at the time that the disclosed device is fashioned or adjusted at the time of retail sale to a color requested by a consumer, much like it is done with existing canisters of paint, which always start out as shades of white and are then modified with by adding a small measure of dye.

Another useful application of the disclosed device is as a touch up, repair and finishing tool. Micro-batches of paint that are conveniently and cleanly packaged to include an applicator may be extremely useful for small job, where a quantity of paint is required to remove a scuff mark, a scratch or crayon doodles. While existing small batch paint packages may be used for such situations, touch ups and small repairs rarely require sixteen square feet or more of paint, which will ultimately end up collecting dust or being discarded.

Another useful application of the disclosed device is to include an applicator as part of the repair or tester kit. A user obtaining the disclosed device may then wash the applicator and reuse it for other small jobs and applications.

### BRIEF DESCRIPTION OF THE DRAWINGS

FIGS. 1A-1D describe an embodiment where the roller is shielded from a paint container with a membrane.

FIGS. 2A-2C describe an embodiment of the disclosed device having a pullout membrane blocking the applicator chamber for a paint chamber.

FIGS. 3A and 3B describe an embodiment of the disclosed device having a refillable paint container.

FIGS. 4A and 4B describe an embodiment of the disclosed device having a reduced collar for removing access paint.

FIGS. 5A-5C and 6A demonstrate an embodiment of the disclosed device having a quantity of paint that is extruded from a storage container onto the applicator as the storage container is threaded onto the applicator sleeve, tearing a protective membrane in the process.

FIGS. 7A-7C is another embodiment showing multiple holding chambers for storing a quantity of paint and an applicator, where upon activation, paint or dye is introduced along the entire length of the applicator.

FIGS. 8A and 8B is another variation of the disclosed device where paint is stored inside an inner cavity and extruded into the applicator when a roller frame is installed.

FIGS. 9A and 9B is another an embodiment of the present invention where paint or dye is introduced using a syringe.

FIGS. 10A and 10B demonstrate an alternative device, where paint is introduced through a pouch whose contents are squeezed into an inner cavity using a roller frame.

FIGS. 11A-11D describe an embodiment where a removable of an inner container causes the applicator to expand, absorbing a quantity of paint from the surrounding cavity.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The present invention presents a device where paint and paint applicator 4 are ready to dispense a small quantity of paint upon emerging from the storage container or sleeve 2. The disclosed device will be able to provide adequate storage and convenient dispensing to about two to six ounces of paint. The storage container 2 may be discarded or recycled as soon as the applicator 4 is removed therefrom. The applicator 4 is discarded once a quantity of paint saturating it have been dispensed. The applicator 4 may also be cleaned and reused in future paint applications. The desired quantity of paint stored, may be stored within a cavity 30, should be sufficient to cover approximately two to four square feet or about a dozen short strokes, or what is necessary to adequately demonstrate the effect of a particular color on an application surface.

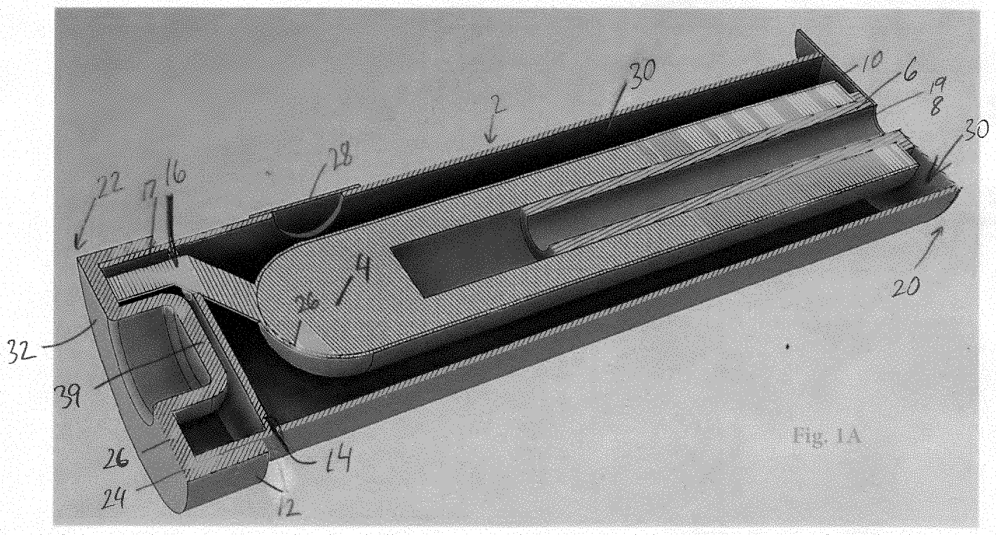

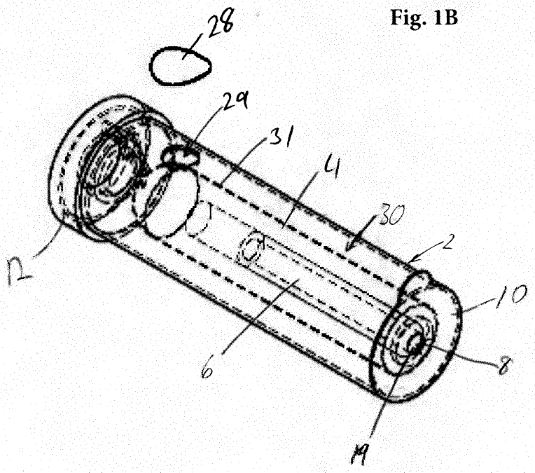

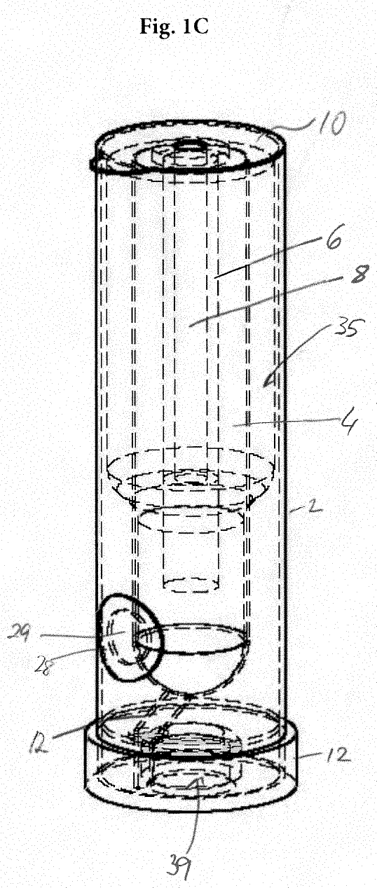

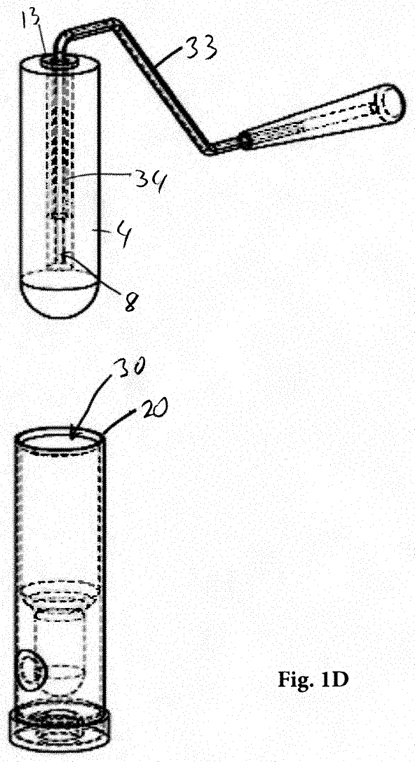

In an embodiment shown on FIGS. 1A-1E the device is comprised of a sleeve 2, a paint roller 4, a core 6, an inner cavity 8, a removable cover 10, a bottom cover 12, a divider 14, a peeler ribbon 16, an opening 17, a paint chamber 30, a bottom end 22, a top end 20 a bottom component 32, a resealable aperture 29 with a cover 28, and a protective membrane 31. A quantity of paint fills the cavity 30 adjacent to the protective membrane 31. The protective membrane 31 fulfills dual purposes of keeping the paint in the cavity 30 away from the roller 4. The protective membrane 31 also constricts the roller 4, so that when the protective membrane 31 is peeled away, the roller expands to its natural diameter and in the process absorbs paint from the surrounding cavity 30.

The applicator 4 is preferably a roll as shown, which may be made from a nap or foam. The roller 4 preferably expands to an average thickness that is intended to create a smooth coat of paint on a target surface.

A peeler ribbon 16 attaches to a point along the protective membrane 31 on one end and to the bottom panel 26 of the bottom cover 12 of the other end. Along its length, the peeler ribbon 16 passes through an opening in the divider 14. The bottom cover 12 comprises the bottom wall 32, and the sidewall 24. When the bottom cover 12 is mounted on the sleeve 2, the sidewall 24 overlaps and surrounds the bottom flange 26. Alternatively, the bottom flange 26 overlaps and surrounds the sidewall 24. The sidewall 24 and the bottom flange 26 are in a substantially tight coupling with each other but will permit axial rotation of the bottom component 12 around the sleeve 2. The attachment between the bottom component 12 and the sleeve 2 that enables this rotation may originate from the coupling of the sidewall 24 and the flange 26 or may contain a pivot connecting the center hollow 39 to the divider 14. The divider component 14 is a structural part of the sleeve 2.

The sleeve 2 is covered with a top cover 10 at the top lip 20. The top cover 10 completely covers the cavity 30 and the applicator 4 from the top of the device. The core 6 provides structural rigidity to the applicator 4 for accepting the leading rod 34 of the roller frame 33, which is mounted into the inner cavity 8 by way of the opening 19. The flange 13 may be part of the core 4 or may be a part of the leading rod 34.

To activate the disclosed device for dispensing, one would need to insert the leading rod 34 into the inner cavity 8, then turn the bottom cover 12 and the sleeve 2 in axially opposite directions of each other. This will cause the peeler ribbon 16 to get dragged with the cover 12 through the opening 17 and create a strain on the protective membrane 31, which will eventually tear to allow the applicator 4 to expand into the paint cavity 30 and the paint in the cavity 30 to begin getting absorbed into the applicator 4. The bottom cover 12 and the peeler ribbon 16 are external activators which cause the paint to adhere to the applicator 4 prior to applicator 4 being removed from the cavity 30. After giving the paint a chance to saturate the applicator 4, the top cover 10 may be peeled off to allow for removal of the sleeve 2. Once the sleeve 2 is removed, the applicator 4 may function as an ordinary roller, or may be discarded after the supply of absorbed paint has been exhausted. The applicator 4 may be reinserted into the sleeve 2 for temporary storage or to capture any residual paint dye within the cavity 30. In an alternative embodiment shown in FIG. 1C, all colorant or paint matter is stored within an internal expansion cavity 35. The paint is then applied to the entire length of the applicator 4, while the applicator 4 is removed from the container 2

The cover 28 forms a window over the aperture 29 and may be used to determine the color of the paint inside the cavity 30. The cover 28 may be resealable to provide an opportunity to add a dye to an existing quantity of paint through the aperture 29.

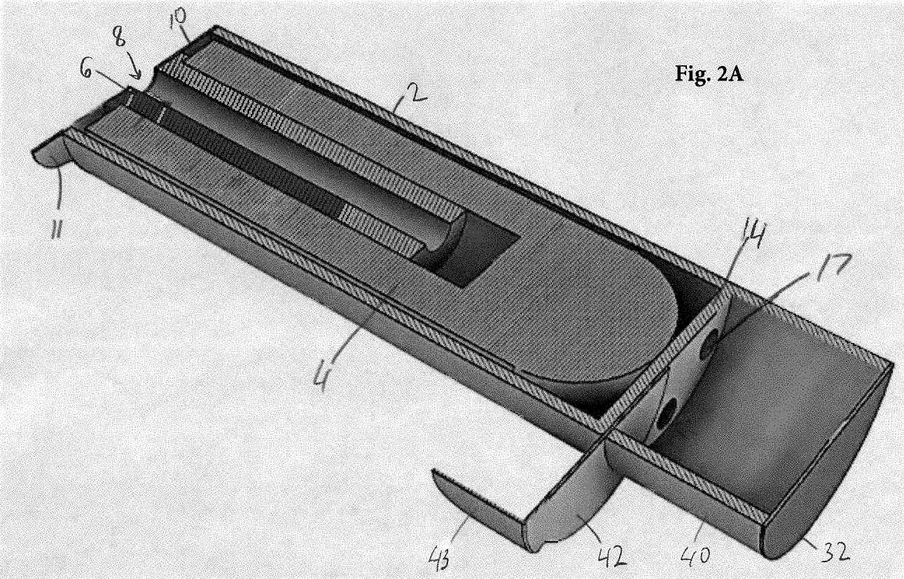

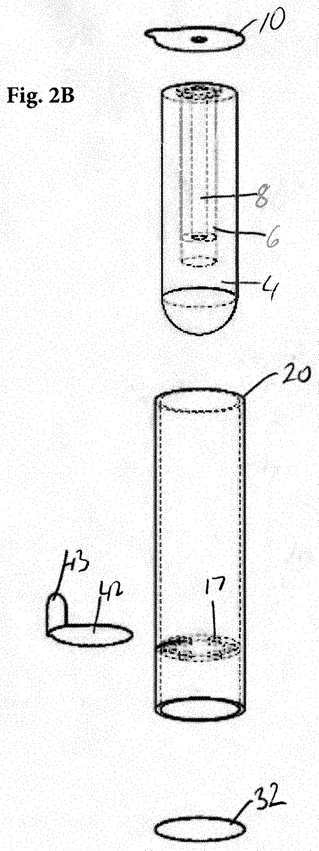

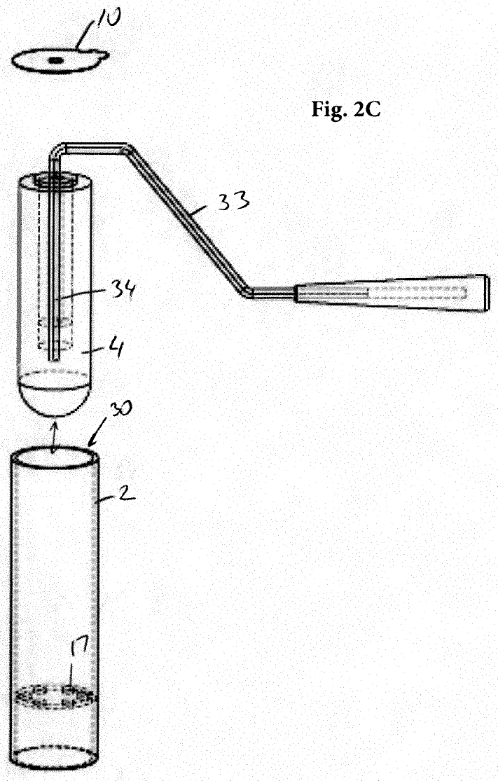

An alternative embodiment of the same inventive concept is shown in FIGS. 2A-2C. Shown is the sleeve 2 having a top cover 10 with a grip area 11 and an opening 8. An applicator 4 is disposed within the cavity 30. The applicator 4 further comprises a core 6 that surrounds an inner cavity 8. A divider 14 separates the cavity 30 and the paint chamber 40. The sleeve 2 and the paint chamber 40 is sealed at the bottom by the bottom wall 32. A removable membrane 42 seals openings 17 in the divider 14. The removable membrane which is shown as a disk, presents a tab 43 through a sidewall 5 of the sleeve 2. The tab 43 is used to displace the removable membrane 42 such that the openings 17 become uncovered. While the device is stored, transported or displayed on a store shelf, the removable membrane 42 prevents the paint inside the paint chamber 40 from entering the cavity 30. Once the device is ready to be activated and used to test paint, a user will grasp the tab 43 to remove the removable membrane 42, thus exposing at least one opening 17. The removable membrane 42 is an external activator since it causes the paint to access the applicator 4 prior to applicator 4 being removed from the cavity 30. The transfer of paint can be propelled into the cavity 30 by shaking the device, or through gravity. A leading rod 34 of a frame 33 is then inserted into the inner cavity 8 and the applicator 4, which would now be saturated with a quantity of paint, would be removed from the cavity 30 after first removing the top cover 10.

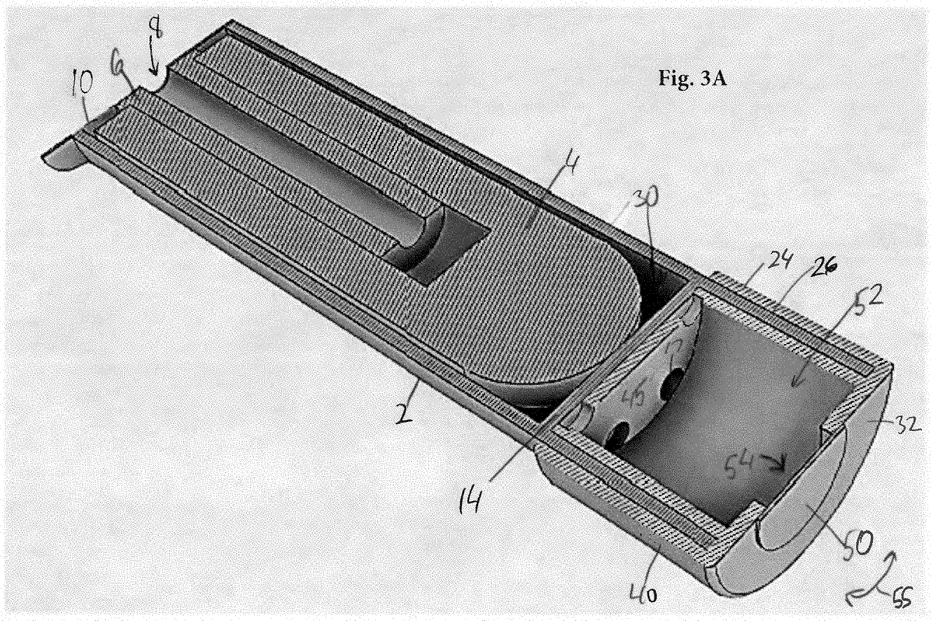

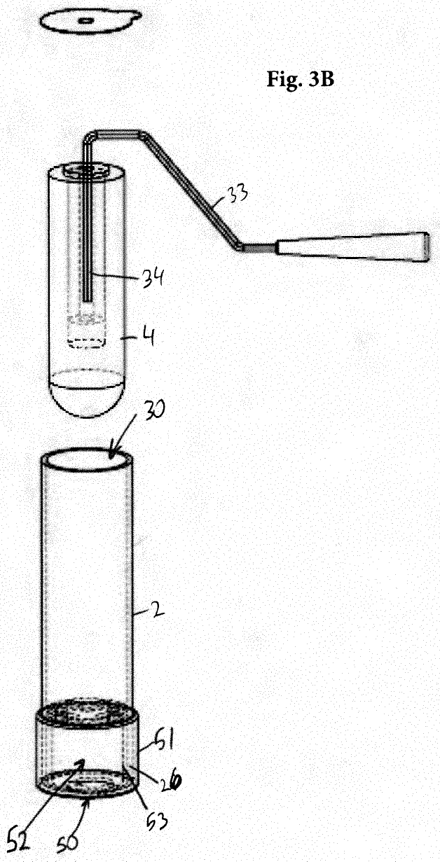

The embodiment shown in FIGS. 2A-2C may need to be packaged with a specific color of paint at the time of production. Or the Alternatively, bottom wall 32 may be removable to admit a measure of colorant or to add a pigment mixture to an existing amount of colorant. FIGS. 3A and 3B demonstrate a variation of this embodiment where a cover 50 seals an opening 54. The opening 54 may be used to add a dye to a quantity of paint stored in the paint cavity 52 of the paint chamber 40, with the cover 50 being resealed once a dye is added. The entire quantity of paint that has been appropriately dyed may be introduced into the paint cavity 52 at a later time through the opening 54 when a consumer purchases the device shown in FIG. 2A and selects a paint color to test. The cover 50 may be transparent or translucent so that a viewer may determine the color of paint stored within the paint chamber 40.

As an alternative to the removable membrane 42, the entire paint chamber 40 may be a separate component mounted onto the flange 26. The paint chamber 40 would then have a sidewall 24 and an inner sidewall 53. The inner sidewall 53 may be required to remove the possibility of paint leaking out of the paint chamber 40 along the exterior of the flange 26. The paint chamber 40 would have a top wall 45, which would be immediately adjacent to the divider 14. The top wall 45 would have openings 17. The openings 17 of the top wall 45 correspond to the openings 17 of the divider 14. When the device is being stored the openings 17 of the top wall 45 and the divider 14 are misaligned and not in communication to prevent any paint from being transferred into the cavity 30. Once the device is ready to dispense, the paint chamber 40 rotates axially in the direction 55 so that openings 17 align and the paint may travel from the paint chamber 40 into the cavity 30, to be absorbed by the applicator 4. Once adequate absorption occurs, a forward rod 34 of a roller frame 33 is inserted into the inner cavity 8, and the top cover 10 is removed to enable for the removal of the roller 4 from the cavity 30. The rotating paint chamber 40 is the external activator of the present embodiment.

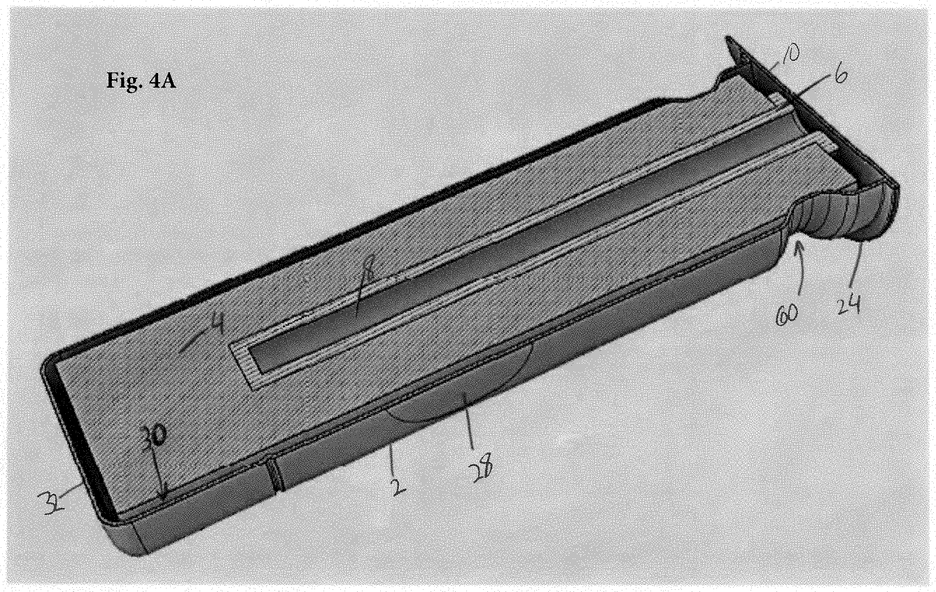

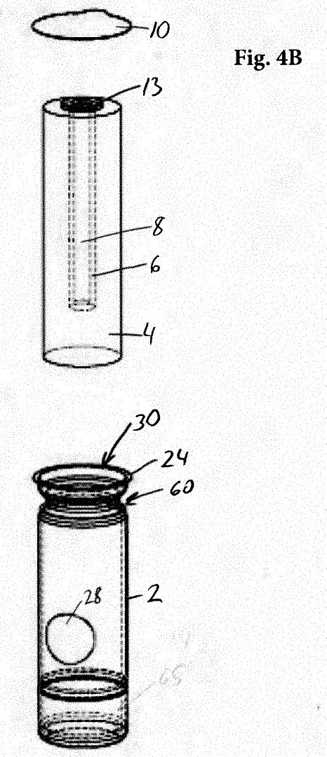

While it may be desired to keep a roller 4 from coming into contact with any paint prior to its removal from the sleeve 2, there may actually be little risk of drying out since the cavity 30 is maintained in a vacuum state due to the top cover 10. Therefore, shown in a variation on FIGS. 4A and 4B, the roller 4 is inserted into the cavity 30 in a pre-saturated state. Or saturation occurs on an inserted roller 4 using injection during assembly of the device. It is important to note that the assembly of the device shown in the foregoing and following figures may occur at a production factory, where the final product is then shipped for eventual retail distribution, or may occur onsite, at a retail facility, where a dispensing machine may be used to insert a roller into the sleeve and then load a quantity of paint with a specified color into a paint chamber 40, the cavity 30 or directly into the roller 4. Once dispensing to a retail consumer completes, a cover 10 is placed onto the upper lip 24 for a vacuum seal of the sleeve 2.

An important feature shown in FIGS. 4A and 4b is a constricted collar 60, which is calibrated to be of a slightly smaller diameter than that of an expanded roller 4. The purpose of the constricted collar 60 is to remove access paint from the roller as it is being removed from the sleeve 2. The constricted collar 60, while shown in FIGS. 4A and 4B among others, may be present in any of the embodiments discussed in this disclosure. Also shown is the cover 28, which in the embodiment shown in FIG. 4B may be a transparent or translucent window in to the cavity 30.

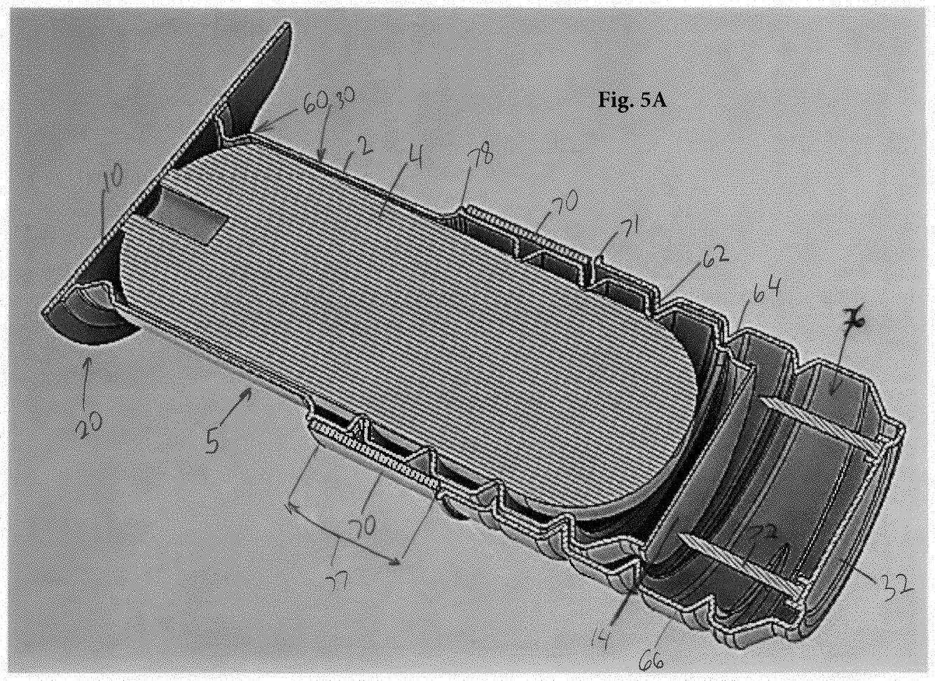

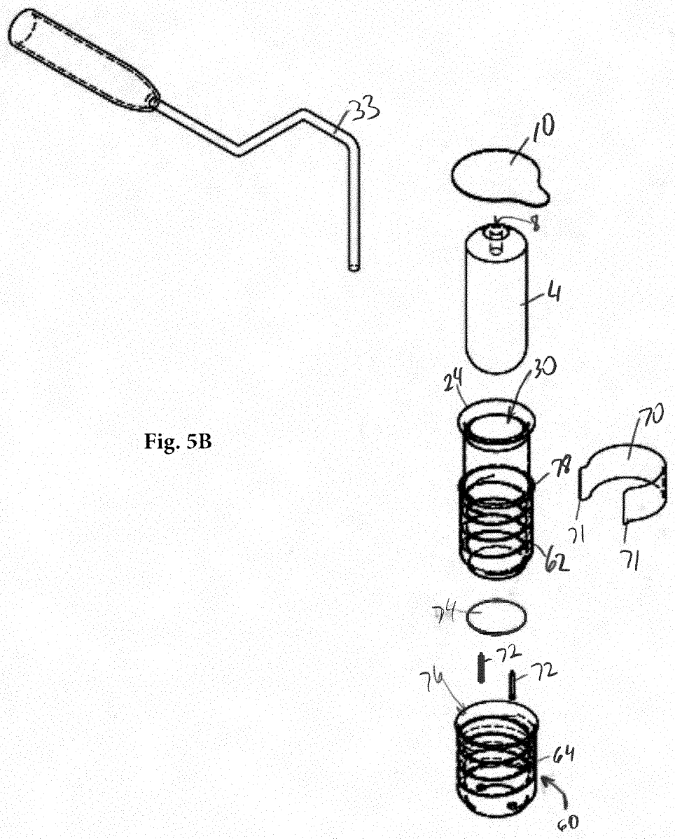

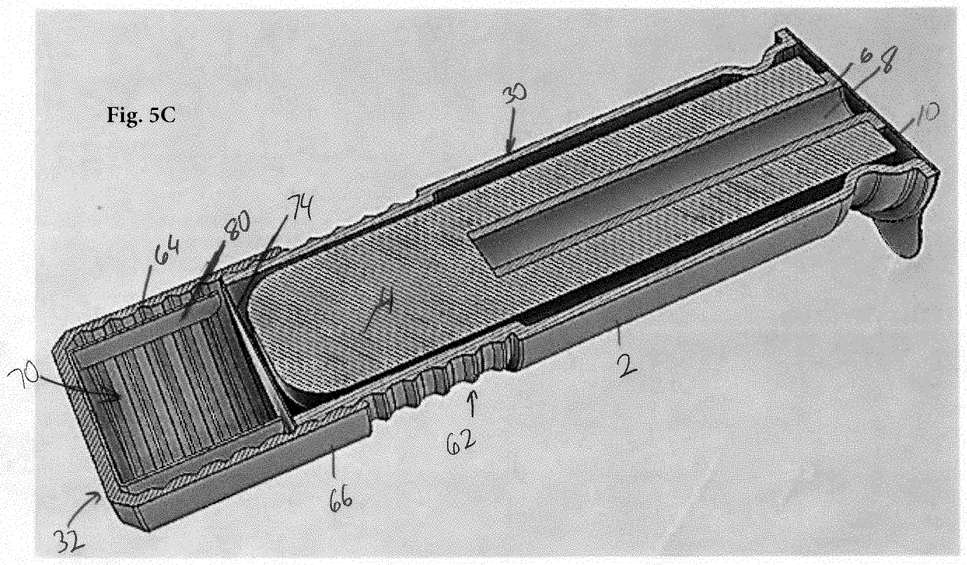

There are multiple variations of components that will enable the inventive concepts. Features disclosed in some variations are applicable to others, when if not explicitly shown in the figures. Demonstrated in FIGS. 5A and 5B is another such variation. Shown is the sleeve 2, the roller 4, a telescoping paint chamber 66, a safety clamp 70 and perforating pins 72. The sleeve 2 contains a constriction collar 60 at the top lip 20. The cover 10 seals the applicator 4 within the cavity 30.

The sidewall 24 of the telescoping paint chamber 66 contains threading 64, which corresponds to the threading 62 on the wall of the sleeve 2. In this association, the cavity 76 of the paint chamber 66 is filled with a quantity of paint and threaded onto the sleeve 2, until the leading lip 71 abuts the bottom edge 73 of the safety clamp 70. The safety clamp 70 is installed below the top flange 78 that is jutting out of the sidewall 5 of the sleeve 2. The bottom edge 73 of the safety clamp 70 is designed to catch and block the leading lip 71 from further twisting up the sidewall 5 of the sleeve 2. The width 77 of the safety claim 70 is slightly greater than the length 79 of the perforating pins 72 to prevent premature or unintended perforation by pins 72 of the bottom wall 74 of the sleeve 2.

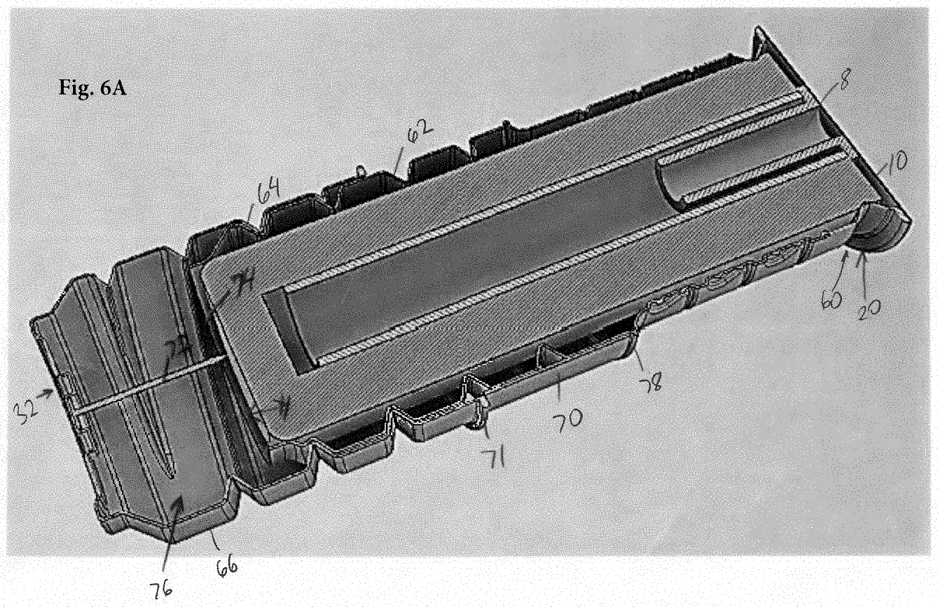

The pins 72 are anchored within the bottom wall 32 of the telescoping chamber 66. While two pins are shown, there may be just one pin, as shown in FIG. 6A. The perforating pins 72 may present a pointed cutting element as shown or a broader cutting edge, substantially in the shape of one or more blades 80, as shown in FIG. 5C.

The purpose of the perforating pins 72 is to serve as the external activator, namely, to pierce and tear the bottom wall 74 releasing paint stored within the cavity 76 into the cavity 30. The threading association (62 and 64) forces the paint up the cavity 30, in the process covering the applicator 4 with paint prior to its removal from the sleeve 2 for a subsequent application of said paint on a desired surface.

The safety clamp 70 remains in place while the device shown in FIGS. 5A and B is being stored. To dispense paint from an applicator of the disclosed device, a user would first remove the safety clamp 70, and begin to twist the telescoping chamber 66 such than the sidewall 24 begins to move up the sidewall 5. This motion forces the perforating pins to eventually come into contact with and then pierce the bottom wall 74, causing the paint held in the paint cavity 76 to enter the cavity 30. As user continues to twist the telescoping chamber 66 in the same direction, the paint is forced further up into the cavity 30, around the exterior of the applicator 4. Full dispensing of paint occurs once the leading lip 71 touches the upper lip 78. At that point, a top cover 10 is removed and a leading wire 34 of the roller frame 33 is inserted into the inner cavity 8. The roller 4 is then removed from the cavity 30 and the sleeve 2 is discarded. The overall length of an applicator 4 is preferably between two and five inches, which closely resembles the length range of the sleeve 2. A paint chamber may be an additional inch to two inches long.

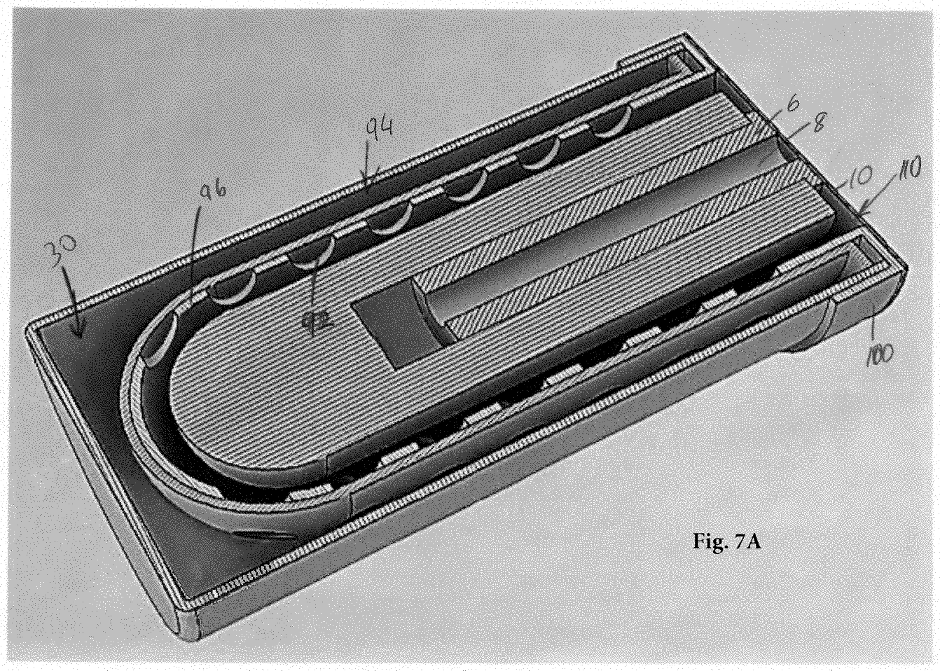

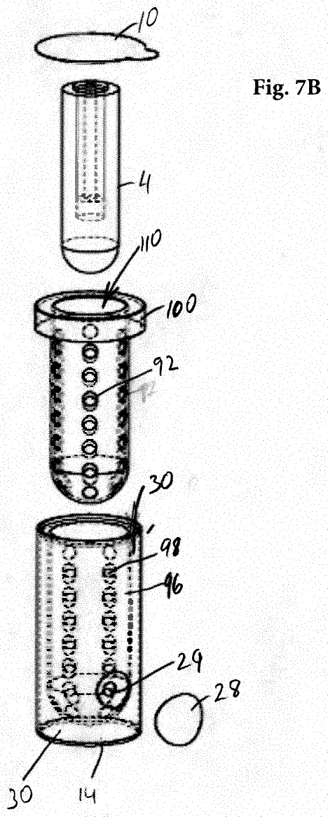

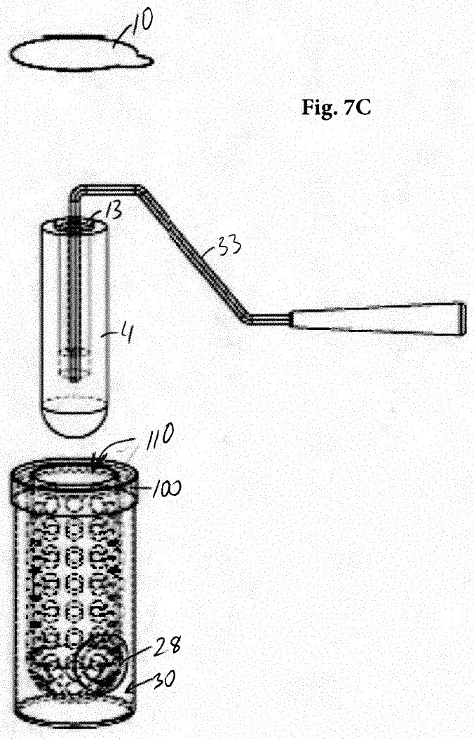

In yet another embodiment of the present invention, which is shown in FIGS. 7A-7C, a quantity of paint may be placed into the cavity 30 between the sidewall 5 and an inner wall 96. The inner wall 96 contains a plurality of openings 98 all along its surface. The openings 98 correspond to openings 92 of an inner chamber 94, which holds the applicator 4. Prior to activation and dispensing, openings 92 and 98 are not aligned, to prevent the applicator cavity 110 from receiving any paint from the cavity 30. The inner wall 96 and the inner chamber 94 may be inserted once a quantity of paint has been added during manufacture. A top flange 100 framing the applicator cavity 110 is mounted over the top lip 20 to seal the paint within the cavity 30. A cover 28 removably installed over an aperture 29 may serve as access to the cavity 30, to fill the cavity with a quantity of paint. The cover 28 may be transparent or translucent in order to view the color of the paint stored within the cavity 30.

To dispense paint using the embodiment shown in FIGS. 7A-7C, a user twists the top flange 100 axially by a prescribed distance, as determined by stopper notches (not shown) on any of the structural components, or until a sign indicative of openings 98 and 92 being in full alignment and communication is displayed in the window 28. The user then removes the top cover 10 and inserts a roller frame 33 into the inner cavity 8 and lifts the applicator 4 out of the applicator cavity 110.

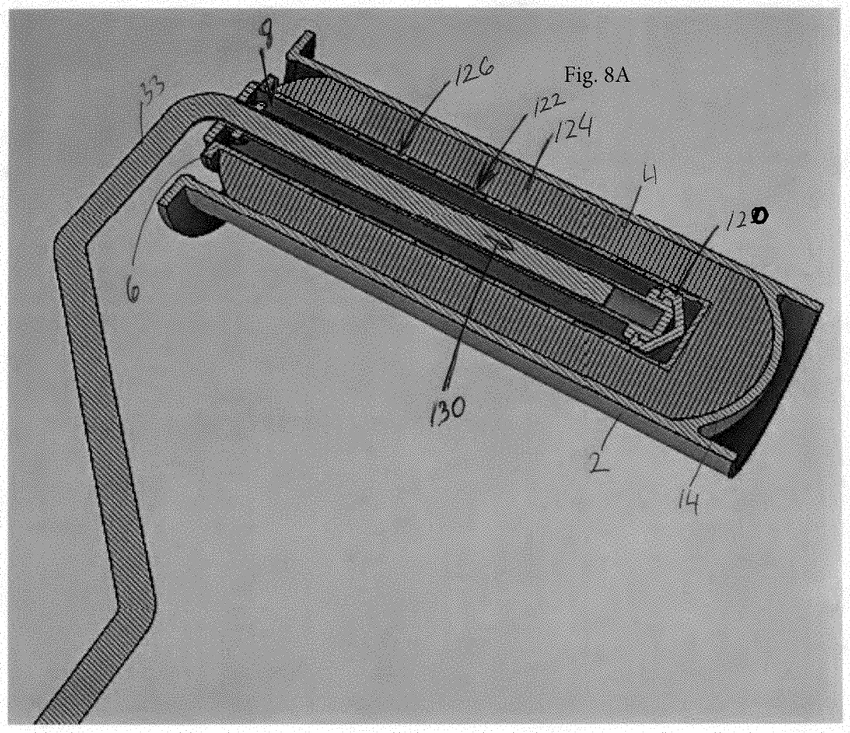

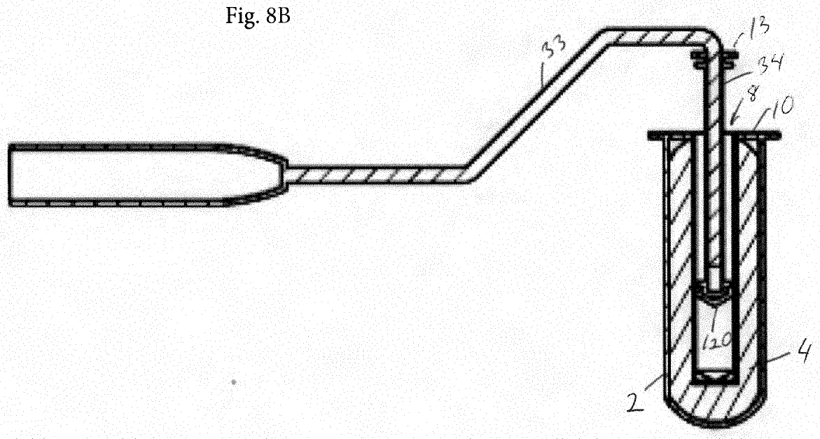

As shown in FIGS. 8A and 8B, the paint may be stored within the inner cavity 8. A leading edge 120 of the leading rod 34 extrudes the paint that is within the inner cavity 8 through openings 126 into the inner body 124 of the applicator 4, thus saturating the applicator 4 with colorant from the direction of the core 6. The openings 126 may contain a protective membrane 124 which is then stripped away as the leading edge 120 advances through the inner cavity 8 in the direction 130. The leading edge 120 may be stored at the rim of the inner opening 8 and have an alcove to accept a leading edge of the leading rod 34.

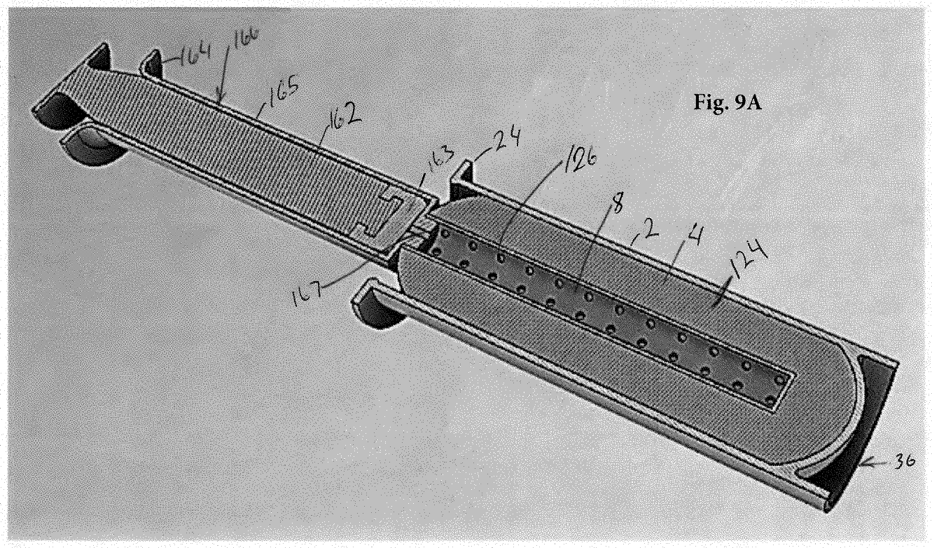

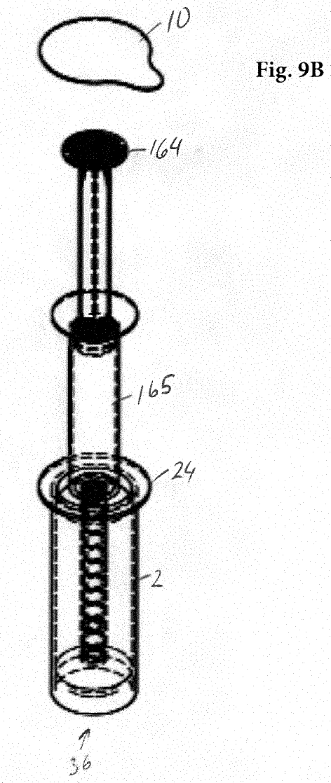

Extrusion of pain through the inner cavity 8 using the openings 126 of in the core 6 may occur in several other ways. In FIGS. 9A and 9B a paint syringe having a storage chamber 165 and a plunger 166. The storage chamber 165 may be filled with a quantity of paint. The extrusion opening 167 corresponds to the inner cavity opening 8 of the applicator 4. As the inner cavity 8 fills up with paint a quantity of it is propelled through the openings 126 and percolates through the applicator 4. Percolation rate increases as the plunger 166 continues to squeeze paint into an already full inner cavity 8 until the plunger travel is completed. The rest of the paint is extruded onto the roller 4 through the openings 126 once the leading rod 34 enters the inner cavity 8. A preferred syringe 165 would contain a plunger edge 163 which extrudes a measure of colorant or a colorant and pigment mixture through the nozzle 167 directly into the inner cavity 8. The pressure of the extrusion from the plunger 162 is sufficient to channel the colorant through the openings 126 and onto the body of 124 of the applicator 4. The bottom 36 forms an alcove to enhance the stability of the bottom while this embodiment is stored on a shelf.

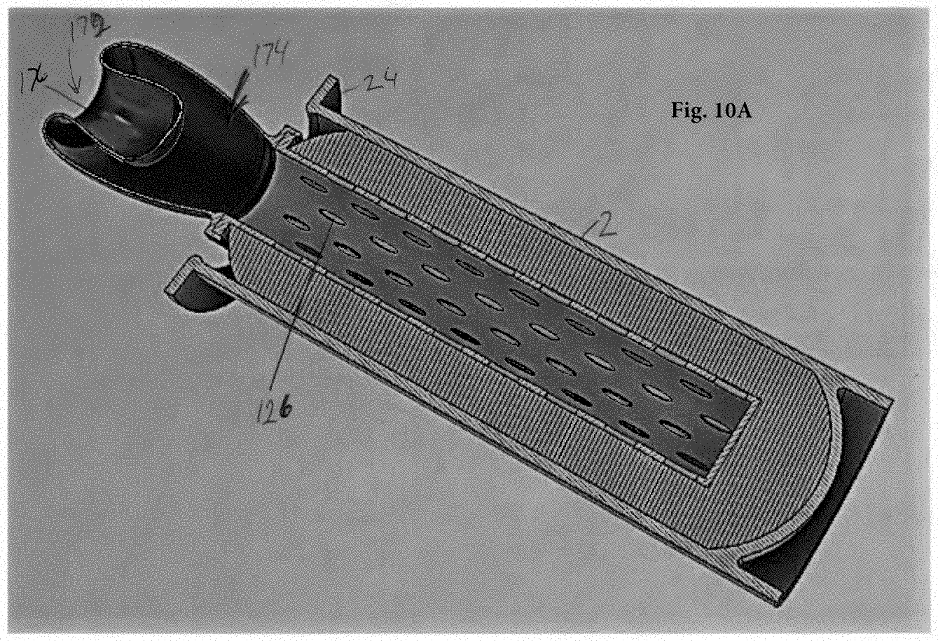

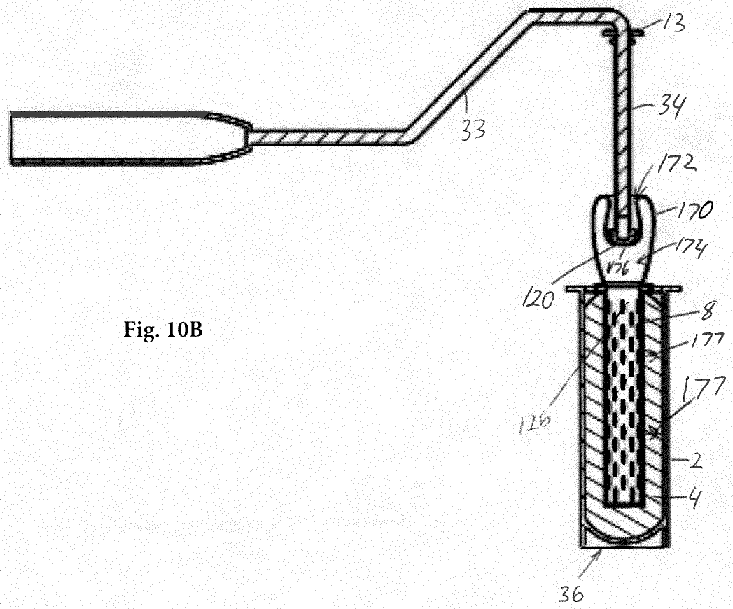

In another variation to the device described in FIGS. 9A and 9B, FIGS. 10A and 10B disclose a pouch 170 that is mounted at the rim of the inner cavity 8. The cavity of the pouch 174 is filled with a quantity of paint. To extrude the paint, a leading edge 120 of a leading wire 34 is used to enter the alcove 172 and begin pressing on the center area 176, pushing paint that was insure the pouch 174 into the inner cavity 8. As the amount of paint within the inner cavity 8 fills up, paint will begin to get extruded through the openings 126 to the applicator 4. The leading rod will push the pouch itself into the inner cavity 8 until it tears the center area 176.

It should be noted that the syringe 165 and the pouch 176 may be sold separately from the sleeve 2. The syringe 165 and the pouch 176 may be the way that a quantity of paint having the desired dye is preloaded at the request of a user and then extruded unto the applicator as provided in FIGS. 9A and 10A.

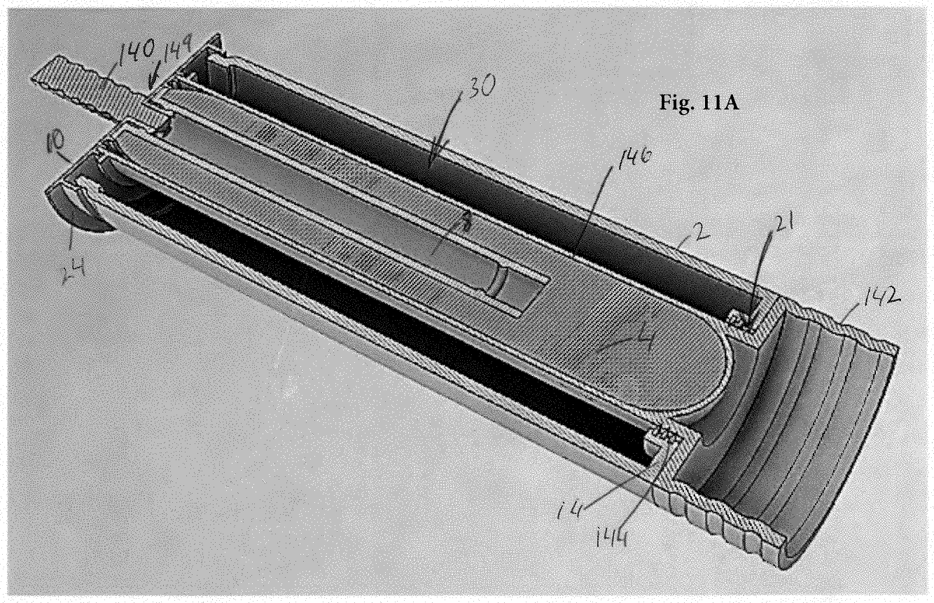

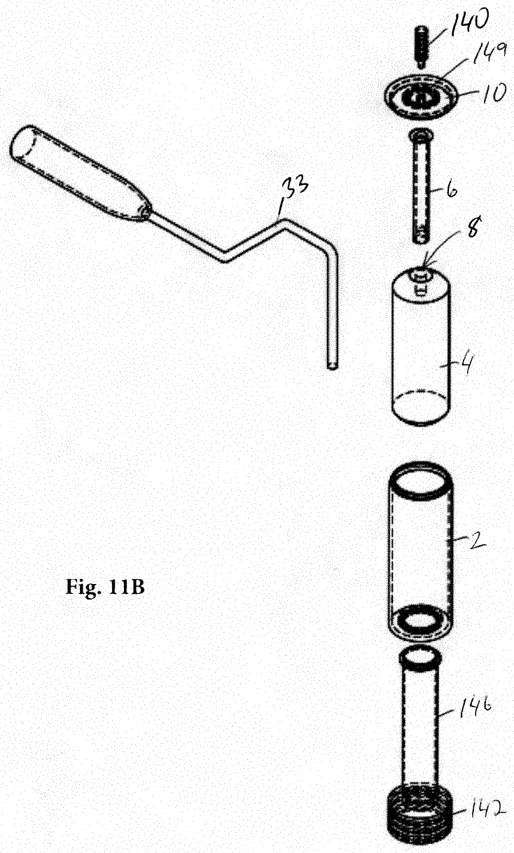

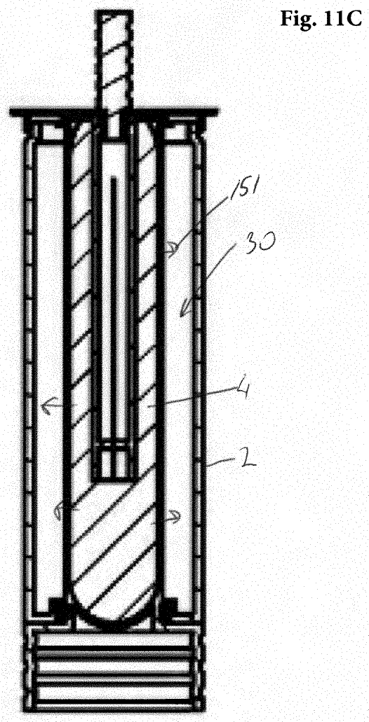

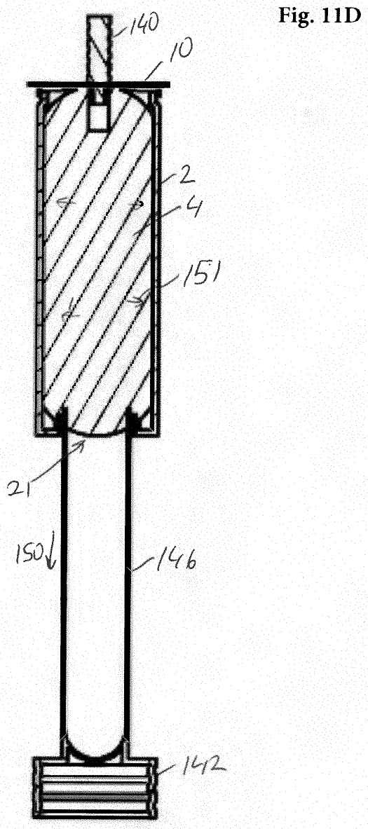

FIGS. 11A-11D demonstrate another embodiment of the present invention. Shown is a sleeve 2, an applicator 4, a cavity 30, an inner opening 8, a bottom cap 142, a container 146, an anchor pin 140. The applicator 4 is stored in a compressed state within the container 146. The container 146 is held in place within an aperture 21 of the divider 14 and snap coupling at point 148 with the top cover 10. The paint is within the cavity 30 while the device is stored. The anchor pin 140 is inserted or threaded into the opening 149 of the top cover 10.

To deploy the device, a user unscrews the bottom cap 142 from the threaded connection 144 and removes the container 146 in the direction 150. The bottom cap 142 is the external activator of the present invention. Because of the anchor pin, the applicator remains within the sleeve 2 and rapidly expands in the direction 151, absorbing paint within the cavity 30 and preventing paint from leaking out through the opening 21. The anchoring pin 140 is then removed together with the top cover 10. The leading wire 34 is then inserted into the inner cavity 8, and the roller 4 is then lifted from the sleeve 2 to begin application of paint.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A colorant testing device comprising: a sleeve, said sleeve having a sidewall enclosing a cavity, said cavity accessed through an opening at top portion of said sidewall; an applicator, said applicator to be used as an applicator of colorant removably disposed within said cavity, wherein said colorant is removable through said opening at top portion of said sidewall; a top cover removably sealing said opening at top portion of said sidewall; a divider, said divider forming a bottom wall for said cavity; a quantity of paint being stored within said sleeve substantially adjacent to said applicator; and wherein said sleeve having an external activator, wherein said external activator causing said colorant to cover said applicator within said cavity.

2. The colorant testing device of claim 1, further comprising a removable encasement, said removable encasement preventing said quantity of paint from accessing said applicator.

3. The colorant testing device of claim 1, wherein said applicator further comprising an inner cavity, said inner cavity accessed by an opening, said opening of said inner cavity being accessible through said opening at said top portion of said sidewall; and wherein said inner cavity capable of accepting a forward rod of a roller frame.

4. The colorant testing device of claim 1, wherein said top porting further comprising a constricting collar, said constricting collar removing access colorant from said applicator when said applicator is extracted from said cavity.

5. The colorant testing device of claim 2, wherein said applicator further comprising an inner cavity, said inner cavity accessed by an opening, said opening of said inner cavity being accessible through said opening at said top portion of said sidewall; and wherein said inner cavity capable of accepting a forward rod of a roller frame.

6. The colorant testing device of claim 5, wherein said protective encasement is connected to said external activator; wherein said external activator is a peeler ribbon having two ends, said peeler ribbon connecting to a bottom cover with its one end and to said protective encasement with its other end; said bottom cover rotatingly attached to at a bottom flange of said sleeve; and wherein an axial rotation of said bottom cover causing said peeler ribbon to tear said protective encasement, said tearing of said protective encasement causing a quantity of colorant to cover said applicator.

7. The colorant testing device of claim 3, wherein said cavity is between a sidewall of said sleeve and an inner wall, said inner wall having a plurality of openings; an inner chamber said inner chamber having a sidewall surrounding an applicator cavity, said sidewall of said inner chamber having a plurality of openings capable of being in communication with said plurality of openings of said inner wall; a top portion of said sidewall of said inner chamber forming a flange above said top portion of said opening of said sleeve; wherein said applicator being stored within said applicator chamber; wherein said flange being an external activator capable of placing opening of said inner wall in communication with opening of said inner chamber to cause a quantity of colorant present in said cavity to travel into said applicator cavity.

8. The colorant testing device of claim 3, wherein said sleeve further comprising a paint chamber having a paint cavity, said paint cavity storing a quantity of colorant; wherein said divider separating said cavity from said paint cavity; wherein said divider having at least one opening, said at least one opening being resealably covered by said external activator; wherein said external activator being a removable membrane; said removable membrane presenting a tab through said sidewall of said sleeve; wherein said tab used to displace said removable membrane causing said quantity of colorant to flow through said at least one opening into said cavity to cover said applicator;

9. The colorant testing device of claim 5, further comprising a resealable cover, said resealable cover providing a transparent covering over an opening, said pointing being disposed on a sidewall of said sleeve.

10. The colorant testing device of claim 8, further comprising a resealable cover, said resealable cover providing a transparent covering over an opening, said pointing being disposed on a wall of said paint chamber.

11. A colorant testing device comprising: a sleeve, said sleeve having a sidewall enclosing a cavity, said cavity accessed through an opening at top portion of said sidewall; an applicator, said applicator to be used as an applicator of colorant removably disposed within said cavity, wherein said applicator further comprises an inner cavity that is accessible through said opening at said top portion of said sidewall, and wherein said applicator is removable through said opening at top portion of said sidewall; a top cover removably sealing said opening at top portion of said sidewall; a divider, said divider forming a bottom wall for said cavity; a paint chamber; said paint chamber removably attached to a bottom end of said sleeve; wherein said divider separating said cavity from a cavity of said paint chamber; a quantity of paint being stored within said cavity of said paint chamber; and wherein said sleeve having an external activator, wherein said external activator causing said colorant to cover said applicator within said cavity.

12. The colorant testing device of claim 11, wherein said top porting further comprising a constricting collar, said constricting collar removing access colorant from said applicator when said applicator is extracted from said cavity.

13. The colorant testing device of claim 11, wherein a sidewall of said paint chamber further comprises threading; said threading matching a threading along a sidewall of said sleeve; said external activator being at least one perforating pin disposed on a bottom wall of said paint chamber, wherein a cutting element of said at least one perforating pin directed at said divider; and wherein axial rotation of said paint chamber along said threading of said sidewall of said sleeve causing said paint chamber to slide up said sidewall of said sleeve thereby causing said at least one perforating pin to meet and pierce said divider, causing a quantity of colorant to cover said applicator.

14. The colorant testing device of claim 13, further comprising a safety clamp, said safety clamp preventing said paint chamber from sliding up said sidewall of said sleeve.

15. The colorant testing device of claim 11, wherein said divider further comprising at least one opening; a paint chamber further comprising a top wall having at least one opening, said top wall of said paint chamber being adjacently mounted to said divider and wherein said at least one opening of said top wall of said paint chamber capable of being in communication with said at least one opening of said divider; wherein said external activator being said paint chamber rotating axially to establish communication of said at least one opening of said divider and said at least one opening of said top wall of said paint chamber.

16. A colorant testing device comprising: a sleeve, said sleeve having a sidewall enclosing a cavity, said cavity accessed through an opening at top portion of said sidewall; an applicator, said applicator to be used as an applicator of colorant removably disposed within said cavity, wherein said colorant is removable through said opening at top portion of said sidewall; a top cover removably sealing said opening at top portion of said sidewall; a divider, said divider forming a bottom wall for said cavity; said applicator further comprising a core forming an inner cavity, wherein said core having a plurality of openings connecting said inner cavity with internal material of said applicator; and wherein a quantity of colorant being delivered to said applicator using said plurality of openings.

17. The colorant testing device of claim 13, further comprising a syringe, wherein said syringe delivering a quantity of colorant into said inner cavity; wherein said colorant percolating through said applicator using said plurality of openings.

18. The colorant testing device of claim 13, wherein a flexible pouch having a quantity of paint attaching to an opening of said inner cavity; wherein an opening of said pouch being in communication with said opening of said inner cavity; a roller frame entering said inner cavity causing said colorant to bet extruded into said cavity; wherein said colorant percolating through said applicator using said plurality of openings.

19. The colorant testing device of claim 13, wherein a quantity of colorant is disposed within said inner cavity; a roller frame entering said inner cavity causing said colorant to bet extruded into said cavity; wherein said colorant percolating through said applicator using said plurality of openings.
